(19) United States
(12) Patent Application Publication
(10) Pub. No.: US 2018/0119741 A1
(43) Pub. Date: May 3, 2018

(54) METHOD FOR PRODUCING ROLLING BODIES FOR ANTI-FRICTION BEARINGS

(71) Applicant: Schaeffler Technologies AG & Co. KG, Herzogenaurach (DE)

(72) Inventors: Frank Jochmann, Obermichelbach (DE); Holger Pätzold, Burgebrach (DE)

(73) Assignee: Schaeffler Technologies AG & Co. KG, Herzogenaurach (DE)

(21) Appl. No.: 15/568,034

(22) PCT Filed: Apr. 18, 2016
(86) PCT No.: PCT/DE2016/200190

§ 371 Date: Oct. 20, 2017

(30) Foreign Application Priority Data
Apr. 20, 2015 (DE) 10 2015 207 106.5

(51) Int. Cl. F16C 33/34; B24B 5/22; B24B 5/313; F16C 19/44

(52) U.S. Cl. CPC F16C 33/34; B24B 5/225; F16C 2220/70; F16C 19/44; B24B 5/313

(57) ABSTRACT

Cylindrical rolling bodies, methods of producing the rolling bodies, and anti-friction bearings including the rolling bodies are disclosed. A method of producing the rolling bodies may include a) providing a spherical blank having a diameter (D) and a radius; and b) grinding the spherical blank into a cylindrical shape having a predefined diameter (d) and a length (L) that corresponds to the diameter (D) to form a cylindrical rolling body. After grinding, the cylindrical rolling body may have crowned end surfaces each having a radius corresponding to the radius of the spherical blank. Centerless cylindrical plunge grinding or centerless cylindrical throughfeed grinding may be used as the grinding method.

### CROSS-REFERENCE TO RELATED APPLICATIONS

This application is the U.S. National Phase of PCT Appln. No. PCT/DE2016/200190 filed Apr. 18, 2016, which claims priority to DE 102015207106.5 filed Apr. 20, 2015, the entire disclosures of which are incorporated by reference herein.

### TECHNICAL FIELD

The disclosure relates to a method for producing rolling bodies with crowned end surfaces for anti-friction bearings, such as bearing needles for high-speed axial needle bearings. The disclosure furthermore relates to rolling bodies produced by this method, to anti-friction bearings having rolling bodies of this kind and to the use thereof.

### BACKGROUND

Plain bearings are increasingly being replaced by axial needle bearings in transmissions. One advantage is that bearing friction may be reduced, with the result that a fuel savings may be achieved in the case of use in motor vehicles, for example.

In the case of transmission applications, high bearing speeds of up to 10,000 rpm are achieved, as a result of which an acceleration of up to 6000 times that of gravity acts radially on the rolling bodies, and this must be absorbed radially by a rolling body cage surrounding the rolling bodies. The rolling bodies are typically bearing needles subject to enhanced quality requirements on the ends thereof, wherein the bearing needles typically have a diameter of less than 2 mm and a length of less than 4 mm.

Bearing needles are currently mass-produced for the industrial and automotive sector using extremely productive manufacturing methods. The procedure in one conventional production method for bearing needles is that, first of all, a metal blank is produced by stretching a wire to a predetermined pre-grinding diameter. Pieces of suitable length are then cut off from the wire by means of a cutting tool. The wire segments produced in this way are then hardened, abraded, ground and superfinished. Cutting takes place at very high speeds with a high-speed cutting tool. In this process, the cutting contour typically formed on the needle end faces is that resulting from the technical process. The shape of the cutting contour is highly dependent on the guidance conditions for the wire in the cutting zone, on the state of wear of the cutting tools and on the wire diameter per se.

Test bed tests have shown that rolling bodies or bearing needles produced in this way may be unsuitable for very high-speed axial needle bearings. The undefined end face contour of the bearing needles can lead to high mechanical stress on the radial contact points of the rolling body pockets of the cage, resulting in a service life of the axial needle bearing which is only unsatisfactorily short. Further reaching optimization of the needle end faces only leads to a successful outcome if the needle end faces are ground and are smoothed and rounded by expensive finishing processes.

This technical problem is discussed in DE 10 2006 041 586 A1 and is solved by arranging a bearing needle and a bearing ball in series in a radial direction in each pocket of the cage of an axial needle bearing, wherein the bearing needles are arranged radially on the inside and the bearing balls are arranged radially on the outside. This ensures that bearing needles with an undefined end face contour cannot destroy the cage, even at high speeds of rotation. However, the disadvantage with this axial needle bearing is that the additionally required balls increase the production costs thereof.

### SUMMARY

Given this background situation, one object of the disclosure is to present a method for producing rolling bodies having crowned end surfaces for anti-friction bearings which is suitable for mass production and can be implemented at low cost. It is another object of the disclosure to specify rolling bodies produced by this method. Finally, it is another object of the disclosure to specify an anti-friction bearing having rolling bodies of this kind and the use thereof.

These objects may be achieved by a method for producing cylindrical rolling bodies with crowned end surfaces for anti-friction bearings, in particular bearing needles for high-speed axial needle bearings, having the following steps:

a) providing a spherical blank having a diameter D which corresponds to the rolling body length L of the rolling body;

b) grinding the spherical blank into a cylindrical shape of the rolling bodies, to the predefined diameter d thereof, wherein centerless cylindrical plunge grinding or centerless cylindrical throughfeed grinding may be used.

The use of centerless cylindrical plunge grinding or centerless cylindrical throughfeed grinding to produce cylindrical rolling bodies having crowned end surfaces makes possible inexpensive mass production at particularly low cost.

The grinding methods for centerless cylindrical plunge grinding and centerless cylindrical throughfeed grinding are already known; see, for example, http://www.hermle-schleiftechnik.de/pages/de_spitzenlos_durchlaufschleifen.php

or http://www.hermle-schleiftechnik.de/pages/de_spitzenlos_einstechschleifen.php

According to the disclosure, use is made here of a spherical blank, which is typically available as a mass-produced product, e.g. as a spherical rolling body, and which is then brought to a predefined diameter d by grinding into the cylindrical shape. Here, the ball diameter D corresponds to the rolling body length L. A material and a heat treatment for the blanks that are suitable for rolling bodies need to be selected in this context.

Use of spherical rolling bodies as blanks is advantageous since they typically already have a precise and laboriously smoothed surface. The radius of the ball corresponds to the radius of the crowned end surfaces of the rolling bodies, which is defined with a geometrically defined concentric crown and has very high surface quality without re-machining.

There is no need for precisely grouped balls since the length tolerance of the bearing needles is many times greater than the ball diameter, which is typically grouped within the μm range. It is therefore possible to use less expensive balls than those used in anti-friction bearings.

The object is furthermore achieved for cylindrical rolling bodies having crowned end surfaces by producing them by the method according to the disclosure.

The cylindrical rolling bodies produced in the manner described above having crowned ends for anti-friction bearings can be used wherever the presence of a defined, concentrically crowned end contour is required. This is the case especially with axial bearings, which are exposed to relatively high bearing speeds with correspondingly high centrifugal forces.

Here, the cylindrical rolling body is designed, in particular, as a bearing needle having a diameter d of less than 2 mm and a length L of less than 4 mm. However, barrel-shaped rolling bodies for toroidal bearings can also be produced in the manner described.

For economic reasons, a ratio of the length L to the diameter d may be no more than 3:1.

The object is furthermore achieved for the anti-friction bearing, such as axial needle bearing or toroidal bearing, if said bearing comprises a rolling body ring, which has a cage and furthermore the rolling bodies according to the disclosure. An anti-friction bearing of this kind can be produced at particularly low cost and can be operated at high speeds.

Use of the anti-friction bearing according to the disclosure at bearing speeds of up to 10,000 revolutions per minute has proven to be feasible.

### BRIEF DESCRIPTION OF THE DRAWINGS

The disclosure is explained by way of example below by means of FIGS. 1 to 4, where:

FIG. 1 shows an axial plan view of a rolling body ring of an axial bearing having a cage with bearing needles accommodated in cage pockets,

FIG. 2 shows a section through a spherical blank and through the rolling body produced therefrom,

FIG. 3 shows a method for using centerless cylindrical plunge grinding or centerless cylindrical throughfeed grinding, in side view, and

FIG. 4 shows a three-dimensional view of the method using centerless cylindrical throughfeed grinding.

### DETAILED DESCRIPTION

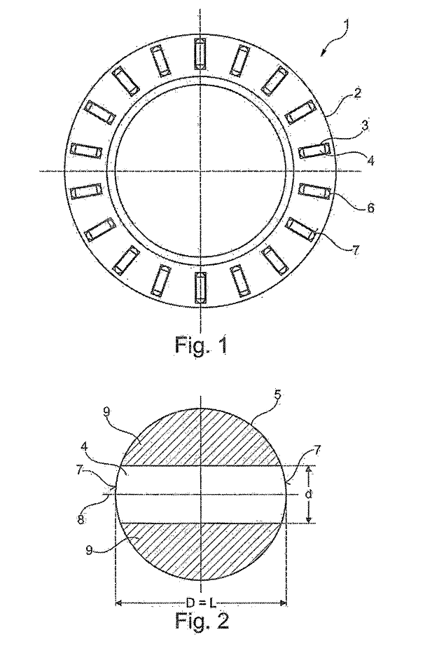

FIG. 1 shows an axial plan view of a rolling body ring 1 of an axial bearing having a cage 2 and having pockets 3, in each of which a cylindrical rolling body 4 in the form of a bearing needle is accommodated. The radial forces generated by the rolling bodies at very high speeds must be absorbed without destruction by the radially outer boundary surface 6 of the pockets 3. For this purpose, the rolling bodies 4 have, at each of the axial ends thereof, a crowned end surface 7, which has a high surface finish, thus ensuring that the rolling bodies 4 do not dig into said outer boundary surfaces 6 of the pockets 3. The diameter d of the bearing needles is typically less than 2 mm, while the length L is less than 4 mm. For economic reasons, the ratio of length L to diameter d may be no more than 3:1.

FIG. 2 shows a section through a spherical blank 5 and through the rolling body 4 produced therefrom. Here, the production of the rolling bodies 4 from the spherical blank 5 involves an anti-friction bearing ball. The length L of the rolling bodies 4 corresponds to the diameter D of the spherical blank 5, while the diameter d of the rolling bodies 4 is a matter of free choice. The rolling body 4 with the axis of rotation 8 thereof is produced by grinding the hatched region 9 to the diameter d, wherein the crowned end surfaces 7 of the rolling body 4 have the radius of the spherical blank 5 and may not require any re-machining. FIG. 2 shows an enlargement of a spherical blank 5 having a diameter of 2.25 mm, from which a bearing needle 4 having a length L=2.25 mm and a diameter d of 1 mm is produced. Here, the blank 5 is ground by means of centerless cylindrical plunge grinding or centerless cylindrical throughfeed grinding to enable the method to be used for mass production.

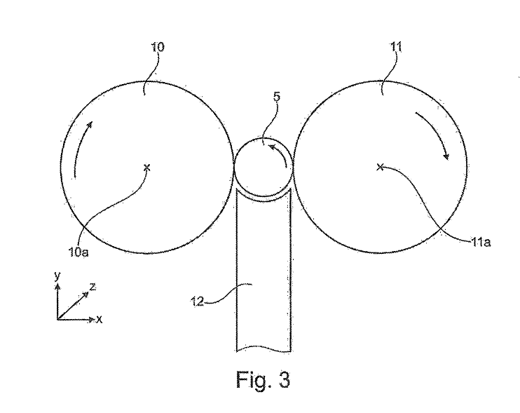

FIG. 3 shows a method according to the disclosure using centerless cylindrical plunge grinding or centerless cylindrical throughfeed grinding on the spherical blanks 5, in side view. Here, the blank 5 is not clamped but is guided between a grinding disk 10 rotating about axis of rotation 10a in the direction of the arrow and a control disk 11 rotating about axis of rotation 11a in the direction of the arrow and, during this process, is held from below by means of a rail 12. A distinction is drawn between plunge grinding, in which in each case only one blank 5 is guided and machined between the grinding disk 10 and the control disk 11, and throughfeed grinding, in which a multiplicity of blanks 5, which are arranged in a row on the rail 12, are transferred in succession between the grinding disk 10 and the control disk 11 by means of the rail 12. During this process, there is a movement of the rail 12 in the direction of the z axis in FIG. 3, i.e. perpendicular to the x-y plane defined by the plane of the drawing.

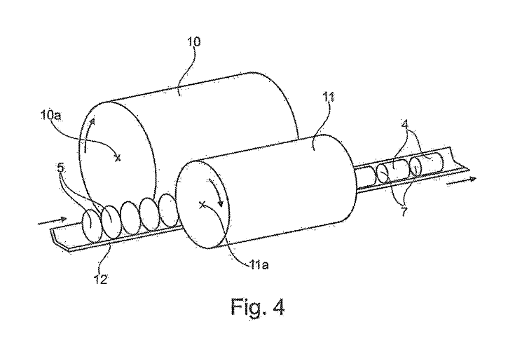

FIG. 4 shows a three-dimensional view of the method shown in FIG. 3 using centerless cylindrical throughfeed grinding. The same reference signs as those in the previous figures denote the same elements. The rail 12 carries a multiplicity of spherical blanks 5 between the grinding disk 10 and the control disk 11, where the blanks 5 are ground into a cylindrical shape of the rolling bodies 4. In this method, very high throughputs can be achieved. After grinding, the crowned end surfaces 7 of the rolling bodies 4 have the radius of the spherical blank 5 and do not require any further remachining.

All the features mentioned in the preceding description of the figures, in the claims and in the introduction to the description can be used both individually and in any desired combination and also include the use of a profiled control disk (feed screw) of the kind used in the production of taper rollers, for example. Thus, the disclosure is not restricted to the combinations of features described and claimed; on the contrary, all combinations of features should be regarded as disclosed.

### LIST OF REFERENCE SIGNS

1 rolling body ring
2 cage
3 pocket
4 rolling body
5 spherical blank
6 radially outer boundary surface of a pocket
7 crowned end surface of the rolling body
8 axis of the rolling body
9 region of the spherical blank which is to be ground
10 grinding disk
10a axis of rotation of the grinding disk
11 control disk
11a axis of rotation of the control disk
12 rail
D diameter of the spherical blank
L length of the rolling body
d diameter of the rolling body

1. A method for producing a cylindrical rolling body with crowned end surfaces for anti-friction bearings, the method comprising:
a) providing a spherical blank having a diameter (D) which corresponds to a length (L) of the cylindrical rolling body; and
b) grinding the spherical blank into a cylindrical shape having a predefined diameter (d) to form the cylindrical rolling body, wherein centerless cylindrical plunge grinding or centerless cylindrical throughfeed grinding is used as the grinding method.

2. A cylindrical rolling body having crowned end surfaces, produced by a method as claimed in claim 1.

3. The cylindrical rolling body as claimed in claim 2, wherein the cylindrical rolling body is a bearing needle having a diameter (d) of less than 2 mm and a length (L) of less than 4 mm.

4. The cylindrical rolling body as claimed in claim 3, wherein a ratio of the length (L) to the diameter (d) is no more than 3:1.

5. An anti-friction bearing, comprising a rolling body ring, which has a cage and furthermore a plurality of rolling bodies as claimed in claim 2.

6. A method of operating the anti-friction bearing as claimed in claim 5, wherein the anti-friction bearing is operated at bearing speeds of up to 10,000 revolutions per minute.

7. A method comprising:
a) providing a spherical blank having a diameter (D) and a radius; and
b) grinding the spherical blank into a cylindrical shape having a predefined diameter (d) and a length (L) that corresponds to the diameter (D) to form a cylindrical rolling body;
wherein, after grinding, the cylindrical rolling body has crowned end surfaces each having a radius corresponding to the radius of the spherical blank.

8. The method of claim 7, wherein the grinding is performed using centerless cylindrical plunge grinding or centerless cylindrical throughfeed grinding.

9. A cylindrical rolling body having crowned end surfaces, produced by a method as claimed in claim 7.

10. The cylindrical rolling body as claimed in claim 9, wherein the cylindrical rolling body is a bearing needle having a diameter (d) of less than 2 mm and a length (L) of less than 4 mm.

11. The cylindrical rolling body as claimed in claim 10, wherein a ratio of the length (L) to the diameter (d) is no more than 3:1.

12. An anti-friction bearing comprising a rolling body ring, which has a cage and furthermore a plurality of rolling bodies as claimed in claim 9.

13. A method of operating the anti-friction bearing as claimed in claim 12, wherein the anti-friction bearing is operated at bearing speeds of up to 10,000 revolutions per minute.
